(19) United States
(12) Patent Application Publication
(10) Pub. No.: US 2003/0057299 A1
(43) Pub. Date: Mar. 27, 2003

(54) Fuel injection nozzle

(76) Inventor: Katsuoki Itoh, Leonberg (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/936,217

(22) PCT Filed: Jan. 5, 2001
(86) PCT No.: PCT/DE01/00016

(30) Foreign Application Priority Data
Jan. 10, 2000 (DE) 100 00 574.8

(51) Int. Cl. F02M 39/00

(52) U.S. Cl. 239/533.3

(57) ABSTRACT

In a fuel injection nozzle having a nozzle body (10), which is provided with at least one injection port (12) and with a conical bearing face (14), and having a nozzle needle (16), which is displaceable in the nozzle body and has an inlet face (18) as well as a radial shoulder (20), adjoining the inlet face downstream, so that a sealing seat which can cooperate with the bearing face is formed at the transition to the inlet face, the object is to improve the precision of fuel meter for the pre-injection. To that end, it is provided that an angle formed by a tangent to the radial shoulder in the region of the sealing seat and by the center axis of the injection nozzle amounts to more than 45°, and that downstream, adjoining the radial shoulder, a circumferential groove (24) is formed, which extends at least as far as the injection port (12), so that in an opening stroke of the nozzle needle for the sake of the pre-injection, the narrowest cross section between the nozzle needle and the nozzle body is formed in the region of the sealing seat.

### PRIOR ART

The invention relates to a fuel injection nozzle having a nozzle body, which is provided with at least one injection port and with a conical bearing face, and having a nozzle needle, which is displaceable in the nozzle body and has an inlet face as well as a radial shoulder, adjoining the inlet face downstream, so that a sealing seat which can cooperate with the bearing face is formed at the transition to the inlet face.

One such fuel injection nozzle is known from German Patent Disclosure DE 195 47 423 A1. The radial shoulder, which is embodied with a depth on the order of magnitude of 0.01 to 0.06 mm, serves to create the most sharp-edged possible cross-sectional transition in the region of the sealing seat, so that the flow cross section resulting when the nozzle needle is open is defined as precisely as possible. However, at a short opening stroke, of the kind executed for a pre-injection, the regions of the nozzle needle adjoining the shoulder downstream form a comparatively long flow conduit, which acts as a throttle, and at which the unavoidable production variations have major effects on the flow. Furthermore, given the gap geometry employed, a temperature-dependent laminar flow develops, which additionally impairs the flow behavior.

The object of the invention is to further develop an injection nozzle of the type defined at the outset in such a way that even at the shortest opening strokes, reliable metering of the quantity of fuel to be injected is possible, as is necessary for a pre-injection.

### ADVANTAGES OF THE INVENTION

A fuel injection nozzle of the type defined at the outset, which has the characteristics of the body of claim 1, has the advantage that because of the circumferential groove, such a large flow cross section is formed downstream of the sealing seat that the resultant flow in the open state of the nozzle needle, as corresponds to a pre-injection, is determined solely by the cross section in the region of the sealing seat. Since furthermore the radial shoulder is embodied with very sharp edges, production variations at this point have only negligible effects on the flow cross section resulting in the open state of the nozzle needle.

Advantageous features of the invention will become apparent from the dependent claims.

### DRAWINGS

The invention is described below in terms of a preferred embodiment, which is shown in the accompanying drawings. Shown in them are:

FIG. 1, a cross section through the front end of an injection nozzle; and

FIG. 2, a graph of the opening cross section between the nozzle needle and the nozzle body, as a function of the stroke of the nozzle needle.

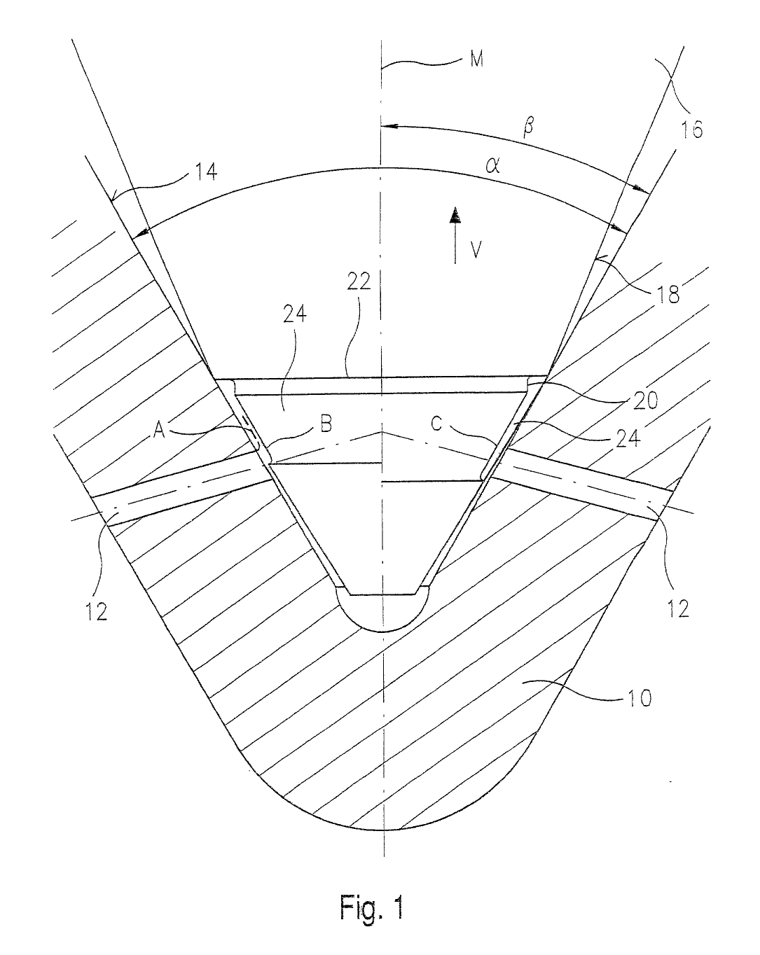

In FIG. 1, the front portion of an injection nozzle is shown, that is, the portion toward a combustion chamber of an internal combustion engine to be supplied. The injection nozzle has a nozzle body 10, which is provided with a plurality of injection ports 12 in the region of its front end. On the inside, the nozzle body 10 is provided with a conical bearing face 14, which has a cone angle α of about 60°.

A nozzle needle 16 is disposed in the interior of the nozzle body 10 and is adjustable between a closed position, in which no fuel can flow from a fuel supply (not shown) to the injection ports 12, and an open position, in which the injection of fuel is possible. The opening stroke executed by the nozzle needle 16 between the closed position and the open position can be controlled such that the injected fuel quantity is adapted to prevailing requirements. In particular, a short opening stroke is possible, so that only a slight fuel quantity is injected in order to achieve a pre-injection, as is the actual opening stroke, which causes a larger fuel quantity to be injected so that a main combustion takes place.

The nozzle needle 16 has an inlet face 18, which in the embodiment shown is embodied as a conical face. The outer contour of the inlet face, seen in the section of FIG. 1, forms an angle β of about 22.5° with the center axis M of the injection nozzle. In a departure from the embodiment shown, other values could also be selected for the angle β, varying between 0° and 45°.

The inlet face 18 is adjoined downstream, that is, toward the injection ports 12, by a radial shoulder 20, forming a sharp-edged sealing seat 22. The shoulder 20 is embodied such that a tangent to its contour (seen in the section of FIG. 1) in the region of the transition to the inlet face 18, that is, in the region of the sealing seat 22, is perpendicular to the center axis M of the injection nozzle, in the embodiment shown.

If the sealing seat 22 is to be embodied with not such sharp edges, that is, with an angle formed between the tangent to the radial shoulder in the region of the sealing seat and the inlet face 18 of less than 112.5°, or if the angle of inclination β of the inlet face 18 is less than the 22.5° shown, then the tangent to the radial shoulder adjoining the sealing seat 22 can also form an angle of less than 90° with the center axis M, or in other words can extend obliquely downward toward the center axis M. To assure the desired sharp-edged sealing seat, the angle formed between the tangent to the shoulder, adjacent to the sealing seat 22, and the center axis M should not be any less than 45°.

The radial shoulder 20, on its downstream side, is embodied such that a tangent to its contour (again as seen in the section of FIG. 1) is parallel to the center axis M. In other words, on its downstream end, the radial shoulder has a cylindrical face, whose center axis coincides with the center axis M of the nozzle needle.

The downstream end of the radial shoulder 20 is adjoined by a circumferential groove 24, which forms a flow gap toward the injection ports 12. Given the contour marked A in FIG. 1, the circumferential groove 24 extends precisely as far as the entrance into the injection ports. For the contour marked B in FIG. 1, the circumferential groove 24 extends as far as the middle of the injection ports 12, and for the contour marked C in FIG. 1, the circumferential groove 24 extends all the way across the injection ports.

The length of the circumferential groove 24 in the axial direction, that is, in accordance with one of the contours A, B or C, represents a compromise between the flow cross section in the region of the circumferential groove, which cross section should be as great as possible, and the volume that is harmful in terms of the hydrocarbon values of the internal combustion engine supplied, and which volume is formed by the circumferential groove and should be as small as possible.

If the nozzle needle 12 executes a short opening stroke, on the order of magnitude of 0.02 to 0.03 mm, so as to attain a pre-injection in which approximately 1 mm³ of fuel is injected, then the sealing seat 22 is lifted from the bearing face 14. Since the sealing seat 22 is adjoined by the radial shoulder 20 and the circumferential groove 24, the narrowest flow cross section is formed by the sealing seat 22; all the flow cross sections adjoining the sealing seat 22 downstream are larger. Because of the sharp-edged geometry employed for the sealing seat 22, unavoidable production variations have a comparatively slight effect on the resultant flow cross section.

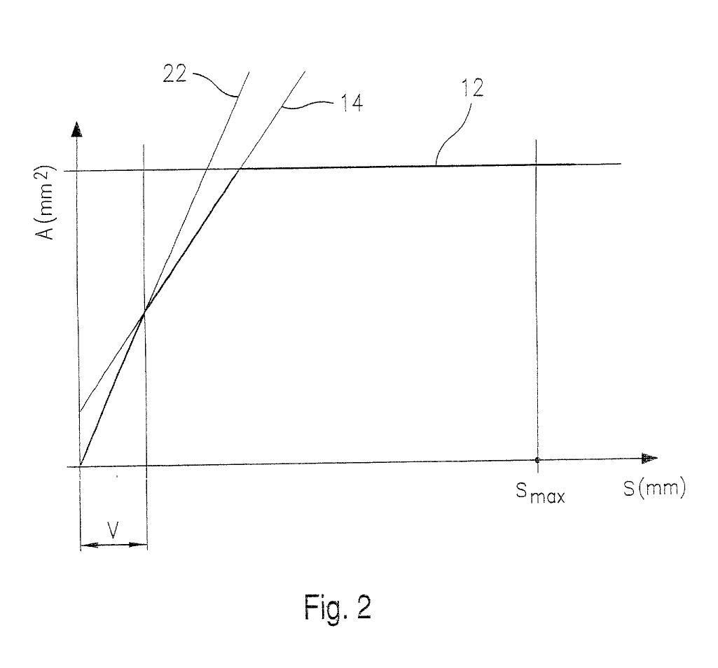

In FIG. 2, the resultant flow cross section A is shown as a function of the needle stroke s. Reference numeral 22 indicates the course of the flow cross section resulting because of the sealing seat 22. Reference numeral 14 indicates the flow cross section that results because of the regions of the nozzle needle and the bearing face that are located downstream of the sealing seat 22. Reference 12, finally, designates the flow cross section that is determined by the injection ports 12.

If the nozzle needle now executes only a short opening stroke V, as is employed for a pre-injection, the resultant flow cross section is then determined solely by the sealing seat 22. Only if a longer opening stroke is executed does a flow cross section initially result that is determined no longer by the sealing seat but rather by the bearing face 14 and the entrance to the injection ports. This is followed, at an even longer opening stroke of the nozzle needle, by a region in which the flow cross section is constant and is determined solely by the cross section of the injection ports 12. This region continues up to the maximum opening stroke sₘₐₓ of the nozzle needle, which is on the order of magnitude of 0.2 to 0.3 mm. For the two latter regions, however, the geometry according to the invention for the nozzle needle has no influence, since it affects only opening strokes of the kind employed for the pre-injection.

1. A fuel injection nozzle having a nozzle body (10), which is provided with at least one injection port (12) and with a conical bearing face (14), and having a nozzle needle (16), which is displaceable in the nozzle body and has an inlet face (18) as well as a radial shoulder (20), adjoining the inlet face downstream, so that a sealing seat which can cooperate with the bearing face is formed at the transition to the inlet face,
characterized in that an angle formed by a tangent to the radial shoulder in the region of the sealing seat and by the center axis of the injection nozzle amounts to more than 45°, and that downstream, adjoining the radial shoulder, a circumferential groove (24) is formed, which extends at least as far as the injection port (12), so that in an opening stroke of the nozzle needle for the sake of the pre-injection, the narrowest cross section between the nozzle needle and the nozzle body is formed in the region of the sealing seat.

2. The injection nozzle of claim 1, characterized in that the circumferential groove (24) extends as far as the middle of the injection port (12).

3. The injection nozzle of claim 1, characterized in that the circumferential groove (24) extends over the entire injection port (12).

4. The injection nozzle of one of the foregoing claims, characterized in that the angle enclosed between the tangent to the radial shoulder (20) and the center axis M of the injection nozzle amounts to approximately 90°.
